(19) United States
(12) Patent Application Publication
(10) Pub. No.: US 2008/0218310 A1
(43) Pub. Date: Sep. 11, 2008

(54) SMART GARMENT

(75) Inventors: Brett G. Alten, Cupertino, CA (US); Robert Edward Borchers, Pleasanton, CA (US)

Correspondence Address: BEYER LAW GROUP LLP/APPLE INC., P.O. BOX 1687, CUPERTINO, CA, 95015-1687, US

(73) Assignee: Apple Inc.

(21) Appl. No.: 11/683,391

(22) Filed: Mar. 7, 2007

(51) Int. Cl. G05B 19/00

(52) U.S. Cl. 340/5.8; 340/505; 702/182

(57) ABSTRACT

A sensor authenticated to a garment transfers information, either wirelessly or wired, to an external data processing device. Such information includes location information, physiometric data of the individual wearing the garment, garment performance and wear data (when the garment is an athletic shoe, for example). The external data processing device can be portable digital media players that are, in turn, in wireless communication with a server computer or other wireless devices.

### CROSS REFERENCE TO RELATED APPLICATIONS

This application is related to i) U.S. patent application Ser. No. 11/439,521, filed May 22, 2006, and entitled “COMMUNICATION PROTOCOL FOR USE WITH PORTABLE ELECTRONIC DEVICES” [Att. Dkt. No.: APL1P492/P4400US1] and ii) U.S. patent application Ser. No. 11/419,737, filed May 22, 2006, and entitled “INTEGRATED MEDIA JUKEBOX AND PHYSIOLOGIC DATA HANDLING APPLICATION” [Att. Dkt. No.: APL1P493/P4401US1] each of which are hereby incorporated by reference herein in their entirety for all purposes.

### FIELD OF THE INVENTION

The invention relates generally to performance monitoring. More particularly, methods and apparatus electronically pairing an authorized garment and a sensor that receives data from the garment are disclosed.

### DESCRIPTION OF RELATED ART

The use of devices to obtain exercise performance information is known. For example, simple mechanical pedometers have been used to obtain information relating to walking or running. A typical mechanical pedometer is a standalone device merely displays an indication of number of steps taken which, typically at most, can be converted to distance traveled by multiplying the number of steps taken by an estimated average stride distance.

More sophisticated devices are also known. For example, as described in U.S. Pat. No. 6,898,550 (the '550 patent), a foot-mounted unit, including a sensor for sensing motion of the foot of a user, is configured to provide motion information—wirelessly—to a wrist-device. The wrist device includes a display for displaying information to the user based upon data accumulated by the foot-mounted unit and transmitted wirelessly to the wrist device. In addition, as described in the '550 patent, the wrist device can be coupled to a computer and/or a network server via a network. The user can operate software running on the computer and/or the server to analyze received data and/or to select operating parameters for the wrist device and/or the foot-mounted unit.

Unfortunately, however, it is becoming more commonly practiced to place the sensor at locations on a garment (shoes, for example) that are not specifically designed to physically accommodate the sensor and/or calibrated to accurately reflect data supplied to the wrist device. For example, Nike Inc. and Apple Inc. have joined forces to provide what is referred to as the Nike iPod Sport Kit™ that is a wireless device kit that allows communication between a pair of specially configured Nike+™ shoes and an iPod nano™. The Nike iPod Sport Kit™ is arranged such that at least one of the Nike+™ shoes includes a sensor (that includes an accelerometer/transmitter) mounted under the inner sole and a receiver that communicates with the iPod nano™. In order to accommodate the sensor and provide appropriate data to the iPod nano™, the shoe must be a Nike+™ model with a special pocket in which to place the sensor. However, some people have taken it upon themselves to remove the sensor from the special pocket of the Nike+™ shoe and place it at inappropriate locations (shoelaces, for example) or place it on non-Nike+™ model shoes.

Therefore, what is desired is a method of electronically pairing a sensor and an authorized garment.

### SUMMARY

An embodiment of this invention pertains to linking an authenticated sensor with one or more authorized garments (such as running shoes, shirts, slacks, etc.) that can provide in addition to current physiologic data of the user, garment performance statistics (i.e., rate of wear of a running shoe), location of the garment and any related information (location of near-by eating establishments, for example) and any other garment related data. In one embodiment, the sensor can be authenticated for use with a particular garment using, for example, an identification device (such as an RFID type device). In this way, only an authenticated sensor can be used to provide information to the wearer of the garment.

The invention can be implemented in numerous ways, including as a method, system, or computer readable medium. Several embodiments of the invention are discussed below. One embodiment of the invention is a method of electronically pairing a sensor and a garment. The method can include, for example, at least: establishing a communication link between the sensor and the garment and electronically pairing the garment and the sensor only if the garment is authorized to be paired with the sensor.

As computer program product, another embodiment of the invention includes at least: computer code for establishing a communication link between the sensor and the garment, computer code for determining if the garment is an authorized garment, and computer code for electronically pairing the garment and the sensor only if the garment is authorized to do so.

As an electronic consumer product system, yet another embodiment of the invention includes, for example, at least: a sensor, and a garment electronically paired with the sensor, wherein the sensor receives data from the garment and passes a portion of the data to an external circuit for further processing.

Other aspects and advantages of the invention will become apparent from the following detailed description, taken in conjunction with the accompanying drawings, illustrating by way of example the principles of the invention.

### BRIEF DESCRIPTION OF THE DRAWINGS

FIG. 1 illustrates an example of a physiologic data-gathering device (sensor) in the form of sensor in accordance with an embodiment of the invention.

FIGS. 2A and 2B illustrate authenticating sensor and garment in accordance with an embodiment of the invention.

FIG. 3 shows representative tag identifier database in accordance with an embodiment of the invention.

FIGS. 4-5 illustrates system for monitoring and/or controlling user exercise or other activity or physiology in accordance with an embodiment of the invention.

FIG. 6 is a flowchart illustrating an example of steps, mostly within the host computer to accomplish transfer of physiologic data between the portable media player and workout data service in accordance with an embodiment of the invention.

FIG. 7 shows a flowchart detailing a process for electronically pairing a sensor and a garment in accordance with an embodiment of the invention.

FIG. 8 shows a running shoe that has been electronically paired with a sensor in accordance with an embodiment of the invention.

FIGS. 9-10 shows the running shoe of FIG. 7 being used in a toe plant type stride.

FIGS. 11-12 shows the running shoe of FIG. 7 being used in a heel plant type stride.

FIG. 13 shows a representative running style profile template in accordance with an embodiment of the invention.

### DETAILED DESCRIPTION

Reference will now be made in detail to selected embodiments of the invention an example of which is illustrated in the accompanying drawings. While the invention will be described in conjunction with selected embodiments, it will be understood that it is not intended to limit the invention to one particular embodiment. To the contrary, it is intended to cover alternatives, modifications, and equivalents as may be included within the spirit and scope of the invention as defined by the appended claims.

Outdoors endurance activities have become very popular not only because they are enjoyable and healthy, but also because they provide opportunities for competition, camaraderie, and a structured regimen. It would be beneficial for an individual participating in an outdoor endurance activity such as running, cross-country skiing, in-line skating, or outdoor swimming to be able to monitor his or her performance in metrics such as speed, distance, slope, elevation, equipment used (thereby correlating an individual's performance to particular running shoes, for example). Furthermore, as part of a particular training program, a user will want to be able to keep track of his or her performance for a particular event as well as be able to store the information for later comparison with subsequent athletic events. For example, if a runner desires to track his or her performance over a period of time, various physical characteristics of the runner, such as age, weight, and gender, for example, could be used to evaluate the runner's performance against both his or her individual performances. In addition to being able to gauge their own particular athletic performances against their own historical record, a user might also like to be able to compare his or her own performance against a reference performance typical of, for example, a person having similar physical characteristics. In this way, a user could gauge his or her own athletic prowess and abilities against an accepted reference and be able to determine, for example, the performance percentile he or she falls in relation to his or her particular cohort of runners.

In addition to being able to ascertain one's own performance against a hypothetical norm, a user may also like to be able to compete against others. Such competitions historically have been held in meets, or other local physical competitions where athletes meet in person and compete. It would also be desirable to be able to compete against an opponent even in those situations where both opponents cannot be physically in the same location using a network such as the Internet. However, being able to track each individual, until recently, has been impractical. In addition, it would be beneficial to be able to correlate a user's performance to particular garments (running time vs. a particular shoe or shoe design) as well as tracking shoe characteristics (such as wear) over time or distance used.

The described embodiments provide an improved method, apparatus and system for automatic monitoring in real-time athletic performance of a user utilizing an authenticated sensor electronically paired with an authorized garment worn by the user in communication with (either wirelessly or wired) an external processing device. As used herein an authorized garment is a garment sanctioned to be electronically paired with an authenticated (i.e., certified) sensor. Once the garment and sensor are electronically paired, the sensor can receive (and in some cases process) sensing information (such as garment performance data or user performance data) received from the garment. Since only authorized garments are configured to electronically pair with authenticated sensors, a user (or manufacturer) can be assured that the sensing data received by the sensor is both accurate and consistent with its intended use (a sensor designed for use with running shoes can not properly be used with dance shoes, for example). In the case of running shoes, if a user owns a number of running shoes, he or she may want to determine if a particular shoe or shoe design facilitates superior performance by the user, determine which shoe design provides for better wear, evaluate a particular shoe against other shoes of similar design, and so on.

Improved security can be provided by authenticating the sensor to only a limited number of garments (such as running shoes) as determined by a user, shoe manufacturer, etc. thereby reducing the incentive for thieves to steal the sensor or finders of lost sensors to keep them. Since the sensor will function properly with only authorized garments, a thief (or recalcitrant finder) can use the sensor only if it is properly authenticated and only then with authorized garments thereby markedly reducing the incentive to steal (or keep) the sensor resulting in vastly improved security than would otherwise be possible.

Furthermore, in addition to performance and improved security, a sensor can provide notification to a user that a particular garment has reached an expected useful lifetime based upon any number of factors, such as, an amount of time that the garment has been used, an amount of wear detected by the sensor, etc. For example, in many cases, a runner will not notice that a running shoe has been worn down to the point where crucial support (arch support, for example) has eroded thereby increasing the likelihood of injury. In this way, by providing a notification that one or both of the running shoes should be replaced, the runner may be better able to avoid injuries related to outworn equipment.

A sensor can also include location-sensing devices (such as a GPS receiver) that provide velocity and/or location data to a processor unit that can be coupled to a database having information such as physical characteristic data such as weight, age, and gender. The database can, in turn, provide an updated readout to a display unit of the user's ongoing athletic performance statistics. Such statistics can include elevation gain, speed, heading, elevation, calories burned, anticipated calories burned (based upon a pre-selected course), and others. Furthermore, the sensor can be coupled to a distributed network of computers, such as the Internet, by way of a wireless device or directly by way of an I/O port coupled to external circuitry, such as a personal computer, personal digital assistant (PDA), modem, etc., or in some cases as part of a peer-to-peer type arrangement of like wireless sensors or other wireless devices. In this way, the user can download selected data (such as other athlete's performance data, selected courses, training programs, etc.) allowing the user to be part of a virtual community of athletes that can interact with each other in real time or virtually. In some embodiments, the sensor can optionally include one or more dead reckoning devices to provide direction information or change of location information. Such dead reckoning devices can include altimeters, accelerometers, cadence measurements sensors and the like.

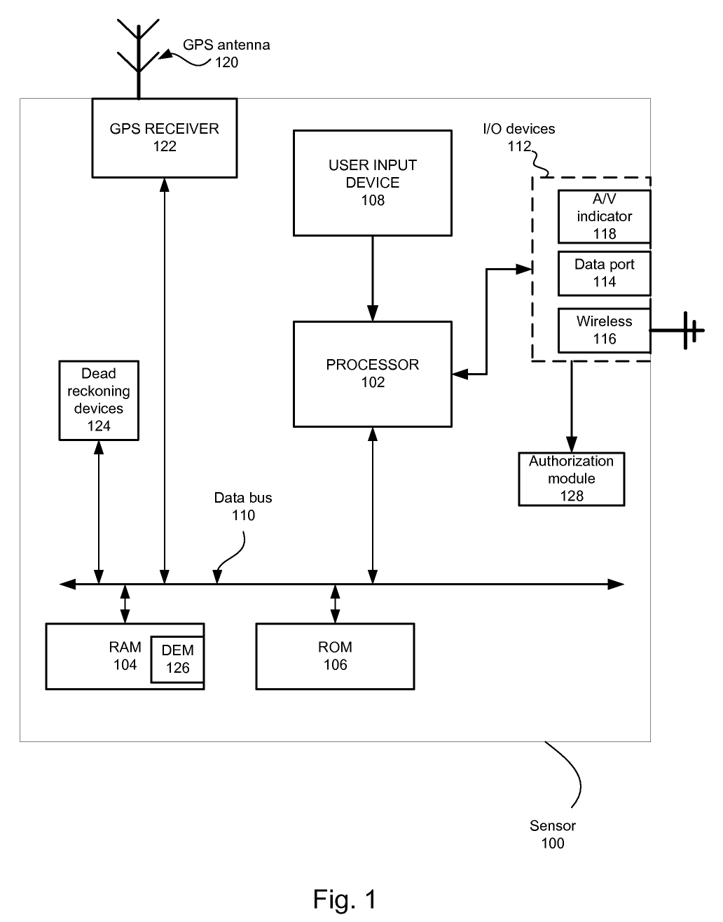

FIG. 1 illustrates an example of sensor 100 in accordance with an embodiment of the invention. Sensor 100 can include processor 102 that can be used to control the overall operation of sensor 100. Data can be stored in RAM 104 that can provide volatile data storage and Read-Only Memory (ROM) 106 for storing programs, utilities or other processes to be executed. Sensor 100 can also include user input device 108 that allows a user to interact with sensor 100. For example, user input device 108 can take a variety of forms, such as a button, keypad, dial, etc. having associated labels to enable a user to know how to request an operation of sensor 100. In one embodiment, the labels are hard or permanent. Alternatively, the labels are soft or can be changed by the user according to a menu of operations. Data bus 110 can facilitate data transfer between at least ROM 106, RAM 104, processor 102 and one or more output devices 112 used to communicate with external circuitry. Such output devices 112 can include I/O data port 114 or wireless interface 116. More generally, they can include an audio and/or visual indicator 118 such as speakers and/or LEDs that can be used to notify a user of an event. Output devices 112 can be in communication with processor 102 directly (or by way of data bus 110). In the case of wireless interface 116, a wireless communication channel can be opened that can be used for transmitting and receiving data between sensor 100 and external circuitry using, for example, RF carrier waves, infrared (IR) signals, etc.

If GPS capable, sensor 100 can utilize line of sight to GPS antenna 120 to receive GPS satellite signals at GPS receiver 122 from one or more GPS satellites to determine a location of sensor 100 and/or a time of observation. In some embodiments, sensor 100 can include one or more dead reckoning devices 124 to provide direction information or change of location information. Such dead reckoning devices include altimeters, accelerometers, cadence measurement sensors and the like. For example, cadence measurement sensors utilize the rhythmic motion associated with the athletic performance (e.g., the user's strides) to extrapolate the user's speed and distance during periods of satellite blockage thereby further enhancing the robustness of the system in challenging environments with high levels of signal blockage. Authorization module 128 can be used to facilitate the electronic pairing of a garment and sensor 100 by processing garment identification credentials.

In those embodiments of sensor 100 that include GPS receiver 122, RAM 104 can store in addition to selected data such as measured user performance metrics, local elevation data in digital elevation model (DEM) database 126 in the form of DEM data. In addition to local elevation data, DEM database 126 can store local points of interest (such as restaurants, rest stops, parks, shops, etc.) that can be updated by the user or downloaded from external circuitry. DEM data can serve to improve the accuracy of the GPS elevation and speed measurements as well as to improve the tolerance of sensor 100 to satellite blockage. Processor 102 can be configured to calculate carrier-wave Doppler-shift based user velocity based upon data received from GPS receiver 122 and DEM database 126 and calculate selected athletic performance feedback data using the calculated user velocity and other data such as the elevation profile and the user physical characteristics. The use of Doppler based velocity measurements gives accuracies in the range of 0.1 mph in typical GPS receivers, which is the highest accuracy typically required for useful assessment of athletic activities.

Sensor 100 can be coupled to a distributed network of computers, such as the Internet, or other like sensors in a peer-to-peer arrangement by way of wireless interface 116 and/or I/O port 114 coupled to external circuitry, such as a personal computer, personal digital assistant (PDA), modem, and the like. In this way, a user can download selected data related to, for example, other athlete's performance data, selected courses, training programs, and so on. The user can also be part of a virtual community of athletes each of whom can interact with each other as well as provide for favorite-routes databases, regimen databases, performance benchmarking, and route mapping and planning, and so on.

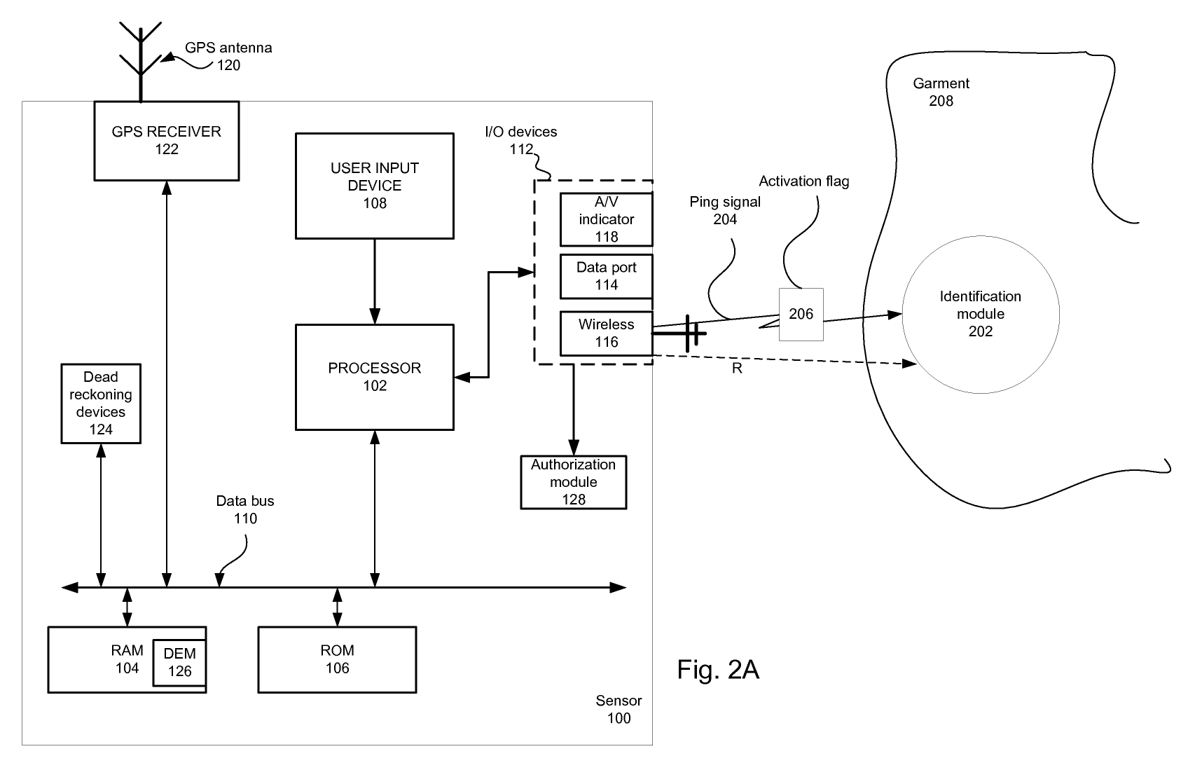

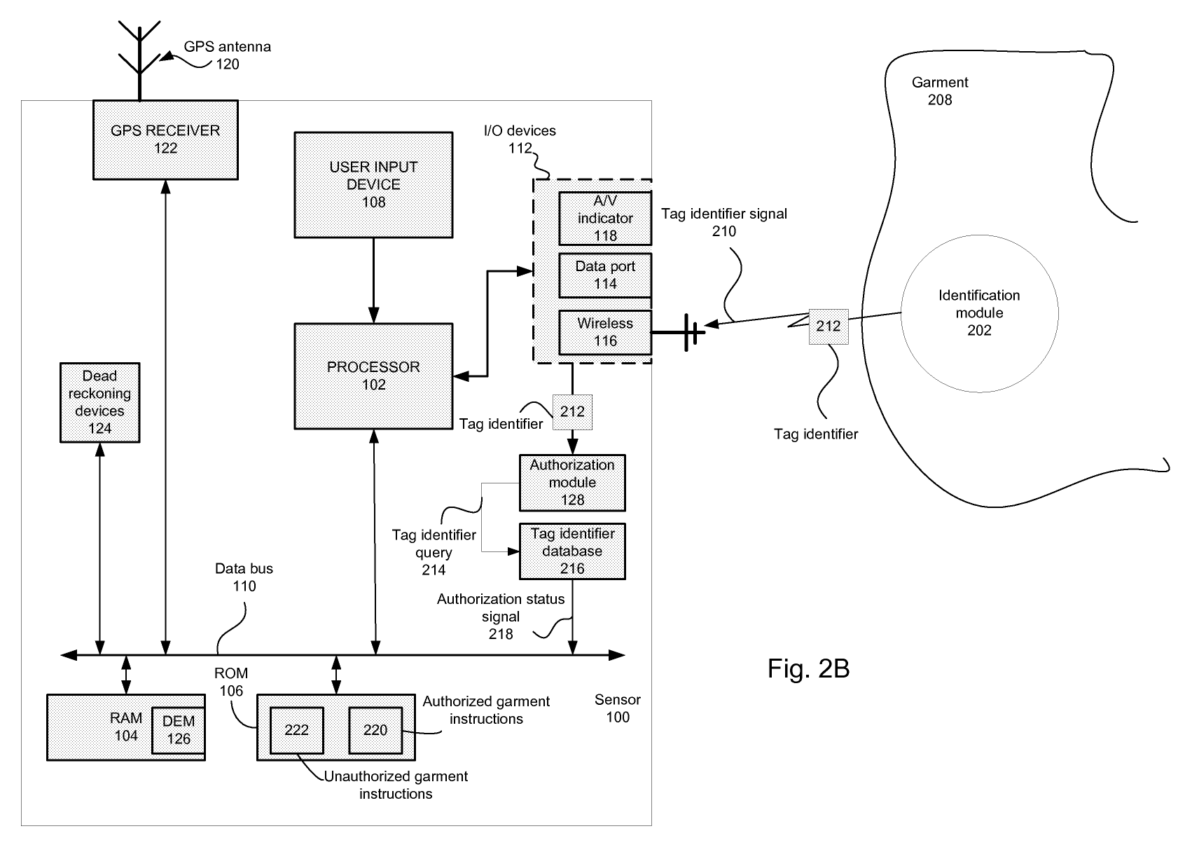

As shown in FIG. 2A, wireless sensor 100 can periodically emit ping signal 204 that can include activation flag 206. In some embodiments, activation flag 206 can activate (i.e., wake up) identification module 202 only when signal strength Sᵣ associated with ping signal 204 is greater than a preset threshold value Sₜₕ. In this way, only those sensors within range R appropriately programmed can be activated, thereby preventing sensors other than those intended for placement on or near the tagged garment from communicating with identification module 202. It should be noted that the actual activation process is not strictly limited to wireless technology. For example, various other activation technologies include, but are not limited to, magnetic activation (such as the Hall effect), resistor/capacitor activation/authorization. In addition to activation techniques discussed, sensor 100 can be automatically deactivated or placed into a hold state when sensor 100 is removed from garment 208 and/or when sensor 100 is moved beyond range R.

Identification module 202 can be attached to or otherwise associated with garment 208 by being sewn onto garment 208, secured to garment 208 by way of fasteners, woven into the fabric of garment 208, and so on. Since it is identification module 202 itself that provides the identification information used to electronically pair sensor 100 and garment 208, it is important that identification module 202 be securely connected to garment 208 such that it does not fall off or otherwise become detached during use (that can result in a warning from the sensor that the authentication has lapsed thereby helping to reduce the incidence of lost or stolen sensors). It should be noted that the identification module 202 could be dedicated to garment 208 (at the time of manufacture of the garment, for example) providing in addition to identification information other useful information (such as date of manufacture, time of use since date of manufacture, and so on) associated with a particular garment. In this way, identification module 202 can provide data storage functions such as backing up selected data, providing a database of information that is matched to garment 208 independent of any particular sensor and so on. This arrangement can be especially helpful in situations where a sensor has been lost or otherwise compromised to the degree where the chances of retrieving any data stored in the sensor would be very remote.

Identification module 202 can be fabricated using radio frequency identification (RFID) technology that can store and remotely retrieve data using devices called RFID tags or transponders. An RFID tag is an object that can be attached to or incorporated into a product, animal, or person for the purpose of identification using radio waves (chip-based RFID tags can contain silicon chips and antennas). Passive tags require no internal power source since they rely upon electrical current induced in the antenna by the incoming radio frequency signal to power up and transmit a response. It should be noted that the response of a passive RFID tag is not necessarily just an ID number, the passive RFID tag can contain non-volatile memory device (such as EEPROM) for storing data. Unlike passive RFID tags, active RFID tags have their own internal power source that is used to power any ICs that generate the outgoing signal. Active tags are typically much more reliable (e.g., fewer errors) than passive tags due to the ability for active tags to conduct a “session” with a reader. Active tags, due to their onboard power supply, also transmit at higher power levels than passive tags, allowing them to be more effective in “RF challenged” environments like water, metal, or at longer distances. A number of non-invasive and reliable power sources such as batteries and in some cases, piezoelectric or kinetic power sources activated by the use of the garment can be used to supply the requisite power for the active RFID tags.

With reference to FIG. 2B, identification module 202 can generate tag identifier signal 210 that can include tag identifier 212 that can include a number of garment identification indicia (e.g., numerical, alphanumeric). Some or all of the garment identification indicia can be encrypted providing additional security. Sensor 100 can wirelessly transmit tag identifier signal 210 (or any appropriate portion thereof) at wireless interface 116 that can be received at authorization module 128. Authorization module 128 can then forward tag identifier query 214 to tag identifier database 216. In the described embodiment, tag identifier database 216 can include a list authorized tag identifiers used to determine an authorization status of tag identifier 212 by, for example, comparing tag identifier 212 to the list of authorized tag identifiers stored in tag identifier database 216. Authorization status signal 218 can be generated indicating whether or not tag identifier 212 matches an authorized tag identifier stored in tag identifier database 216. Authorization status signal 218 can be forwarded to processor 102 that can, in turn, execute instructions based upon authorization status signal 218. For example, if authorization status signal 218 indicates that tag identifier 212 matches an entry in the list of authorized tag identifiers, then processor 102 can be directed to execute authorized garment instruction set 220. However, if authorization status signal 218 indicates tag identifier 212 does not match an entry in the list of authorized tag identifiers (i.e., no match), processor 102 can be directed to execute unauthorized garment instruction set 222 indicating that the garment identification information does not correspond to an authorized garment.

For example, when processor 102 executes unauthorized garment instruction set 222, sensor 100 can be instructed by processor 102 to perform a number of predetermined actions consistent with an unauthorized garment. Such pre-determined actions can include, for example, issuing an alert by way of audio/visual output device 118 (beep from a speaker, flashing LED, etc.) that notifies the user that the garment (or more accurately, the identification module associated with the garment) is not authorized to be used with sensor 100 and to display actions that can be taken by the user to rectify the condition. Such actions can include instructing the user to register the tag identifier associated with the unauthorized garment or instructing sensor 100 to shut down in order to prevent what appears to be an attempt to pair sensor 100 with an unauthorized garment. In this case, sensor 100 can then be restarted by a user entering an authorization code by way of user input device 108, for example, thereby preventing unauthorized pairing of sensor 100 with garment 208.

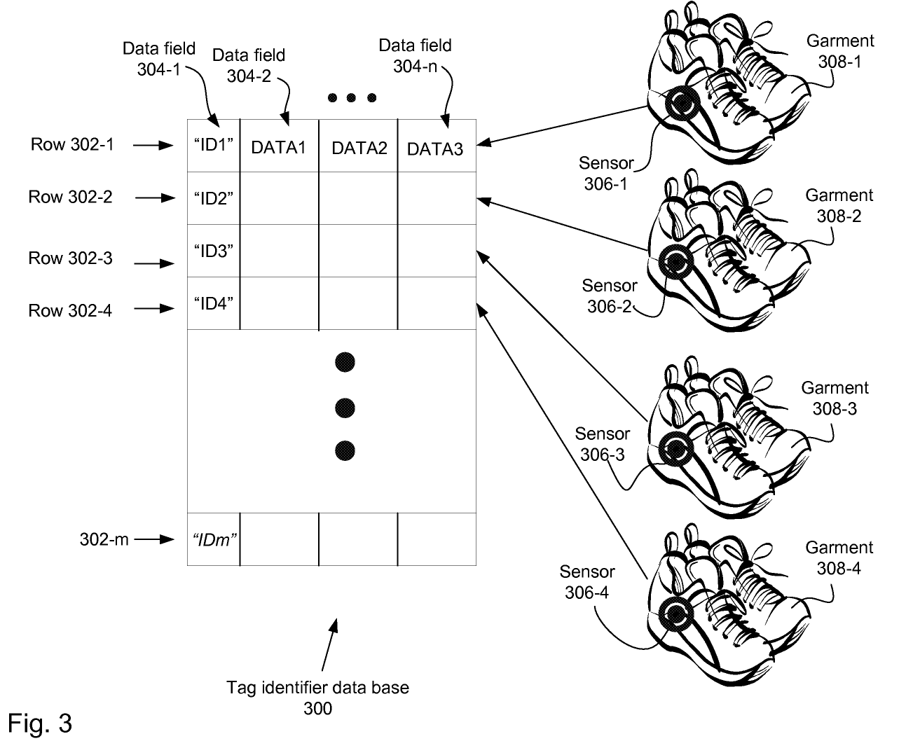

When processor 102 executes authorized garment instruction set 220, sensor 100 can be instructed by processor 102 to perform a number of predetermined actions consistent with an authorized garment. Such predetermined actions can include accessing tag identifier database 216 in preparation for a forthcoming activity for which sensor 100 would generate performance data of either (or both) garment 208 and/or the user. In the described embodiment, tag identifier database 216 can include information for all registered identification modules and associated garments an example of which is shown in FIG. 3.

FIG. 3 shows representative tag identifier database 300 in accordance with an embodiment of the invention. It should be noted that tag identifier database 300 is a particular implementation of tag identifier database 216 described above and is therefore only exemplary in nature. Tag identifier database 300 can be constructed along the lines of a m×n memory array having m rows (302-1 through 302-m), each corresponding to a particular tag identifier (that, in turn, can be associated with a particular garment) and n columns each being of suitable size for storing data related to a particular garment in a data field of appropriate length. For example, row 302-1 includes data fields 304-1 through 304-n where data field 304-1 is used to store tag identifier “ID1” corresponding to tag identifier stored in sensor 306-1 attached to garment (in this case a running shoe) 308-1. Remaining data fields 304-2 through 304-n can be used to store any data deemed appropriate such as performance data, garment wear data, purchase date, and so on that can be used in subsequent analysis. It should be noted that at any time, any of sensors 306 can be swapped for any other sensor or interchanged between any of garments 308 thereby affording the user complete freedom of association between available sensors, garment inventory, or sensor/garment replacements.

In this way, an extensive database of pertinent garment data can be stored and made available for the user and any other interested party such as a manufacturer interested in garment wear patterns, a user interested in correlating specific garment design to user performance statistics as would be the case with running shoes and run times, for example. Such data can include specific performance data (number of hours of use from time of purchase, for example) and any other data deemed appropriate. It should be noted that there could be a one-to-one correspondence between a particular garment and a particular tag identifier at a time. However, at any time, a particular tag identifier can be re-assigned to any other garment simply by removing the identification module associated with the particular tag identifier from one garment and placing it onto or in another garment. Moreover, the tag identifier can itself be re-assigned by, for example, re-programming a non-volatile type memory device (incorporated in the identification module) into which the particular tag identifier had been previously programmed.

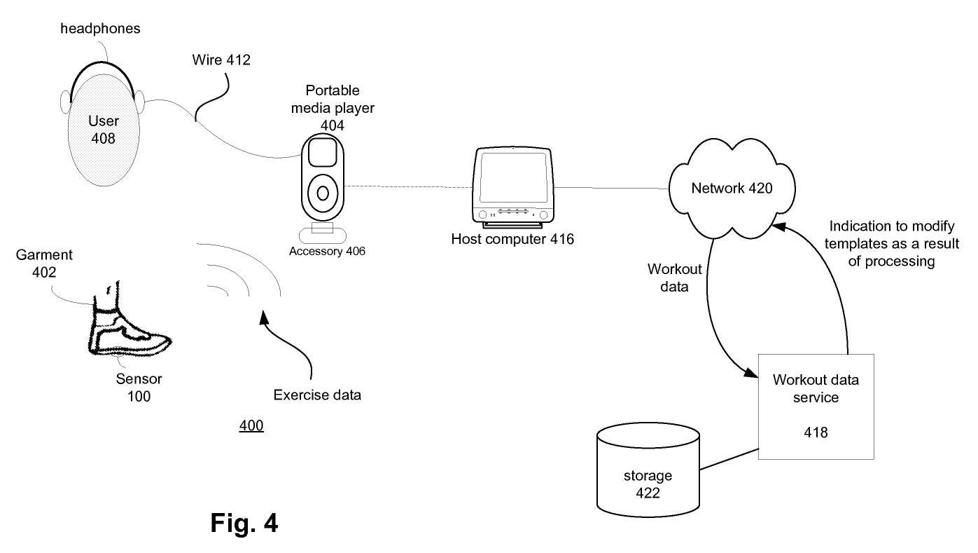

FIG. 4 illustrates system 400 for monitoring and/or controlling user exercise or other activity or physiology in accordance with an embodiment of the invention. System 400 can include sensor 100 coupled to garment 402 (which in this case takes the form of an athletic shoe) in communication with processing device 404 that can take the form of portable media player 404. User exercise data can be communicated (in this example, wirelessly) from sensor 100 configured for gathering physiological data of a user (such as a sensor to sense the foot motion of a user) to portable media player 404. In one example, the user exercise data is wirelessly transmitted via accessory 406 which can be configured to selectively attach to a data port of portable media player 404. An example of accessory 406, and the interoperation of the accessory with portable media player 404, is described in U.S. patent application Ser. No. 11/439,521 filed May 22, 2006, and entitled “COMMUNICATION PROTOCOL FOR USE WITH PORTABLE ELECTRONIC DEVICES” [Att. Dkt. No.: APL1P492/P4400US1] incorporated by reference herein.

User physiological data can be accumulated by sensor 100 and then provided wirelessly to portable media player 404. Meanwhile, cues relative to the exercise (e.g., audio cues) provided by, for example, exercise templates retrieved from portable media player 404 to the user (by way of, for example, wire 412 and headphones 414). In addition to providing the cues relative to the exercise, portable media player 404 can also be configured to provide playback of media (such as audio media) to user 408 (also via wire 412 and headphones 414 or any other appropriate communication channel) that could, for example, be coordinated with the exercise cues. For example, playback of media can be accomplished by playing back music from a play list created using iTunes® software application provided by Apple Computer, Inc., running on host computer 416 and then downloaded to portable media player 404 for subsequent playback. In this way, play lists (and any other suitable media) can be associated with exercise templates.

Portable media player 404 can also be configured to provide physiologic data to workout data service 418 via host computer 416 that can be configured to operate in any number of modes. For example, host computer 416 can operate as a conduit for providing the physiologic data to workout data service 418. Alternatively, host computer 416 can process the physiologic data and/or temporarily store the physiologic data for later forwarding such as, for example, during a temporary loss of connection between host computer 416 and service 418 via network 420. Furthermore, physiologic data can be processed at workout data service 418 in any number of ways. For example, physiologic data from one user can be processed in view of physiologic data from other users in order to compare the users in terms of performance. In another example, the physiologic data can be processed by workout data service 418 to determine a suggested template change such as changing the clues to provide motivation at a particular portion of the workout. As another example, based on play lists associated with that workout by other users, a different play list (or changes to the play list) can be suggested for a particular workout.

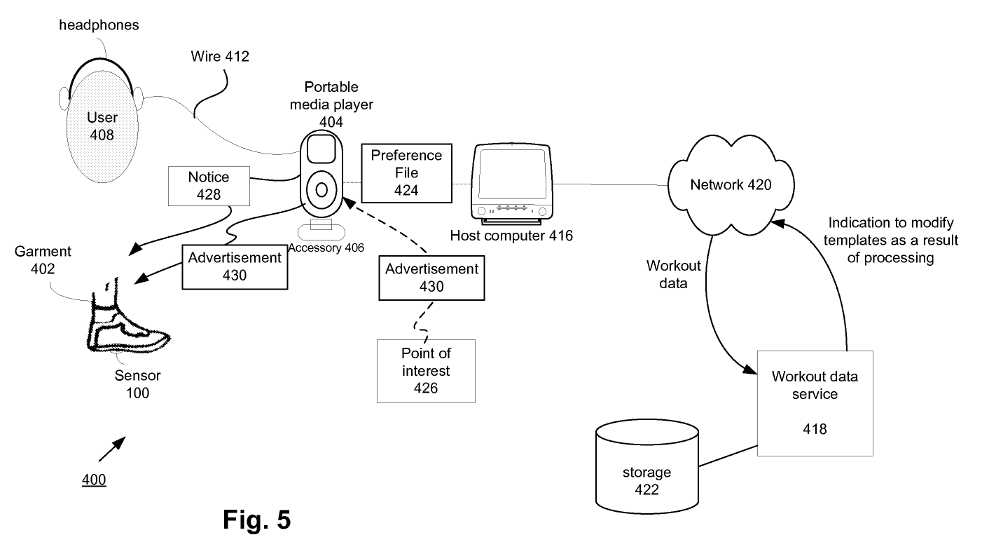

In addition to providing physiologic data, sensor 100 can provide indications of nearby locations of interest as shown in FIG. 5. For example, when sensor 100 incorporates real time location technology (such as GPS), sensor 100 can periodically check for nearby points of interest (included in a DEM database in the case of a GPS enabled system) provided, in some cases, by the user and in other cases by a workout template specific for the area in which the user plans to exercise. For example, in a GPS based system, prior to a workout (or other anticipated excursion such as a hike or bike ride), the user can download a list of preferred establishments (restrooms, restaurants, etc.) to the DEM database 126 specific for the area in which the user plans to exercise (local parks, bike routes, jogging trails, etc). The downloading can be accomplished by, for example, accessing an external device (such as host computer 416 or media player unit 404) in which is stored preference file 424 that includes indicators of points of interest for the designated area. When the user approaches one of the points of interest (restaurant 426, for example) while exercising, sensor 100 can issue notification 428 that the user is within a pre-determined distance of the nearby point of interest thereby providing the user the option to stop or continue the planned excursion unabated. Moreover, the nearby point of interest (i.e., restaurant 426) can also push information 430 to the user by, for example, displaying advertisements in addition to the notification that the user is within the pre-determined distance.

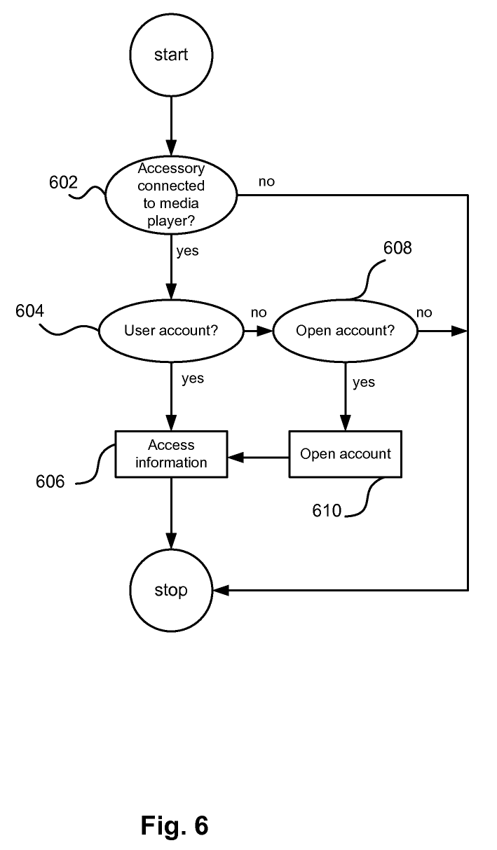

FIG. 6 is a flowchart illustrating a process 600 to accomplish transfer of physiologic data between portable media player 404 and workout data service 418. At 602, a determination is made if accessory 406 is connected to portable media player 404 (which, if connected, would allow physiological data to be received by portable media player 404 from sensor 100). This determination can be accomplished by, for example, using configuration data provided to host computer 416 when portable media player 404 and host computer 416 are connected using a handshake protocol. The configuration data can include such information as device characteristics, capabilities and/or activities of portable media player 404 and so on. If it is determined at 602 that accessory 406 is not connected to portable media player 404, then process 600 ends, otherwise, at 604, a determination is made if the user has an account at workout data service 418. If it is determined that the user does have an account, then processing continues to 606, otherwise, the user is requested to open an account at 608 before going any further. If the user does not desire to open an account, then process 600 ends, otherwise, an account is opened at 610. Once an account is opened, at 606, computer 416 accesses the physiologic data, if any, stored in portable media player 404 and provides the physiologic data to workout data service 418 to be associated with the user's account. In some cases, some or all of the provided physiologic data can be retained on portable media player 404 for easy reference by the user (such as during or in preparation for a workout). For example, a portion of the physiologic data corresponding to the last few workouts can be retained in storage of portable media player 404 that can then be displayed by way of a display screen of the portable media player 404.

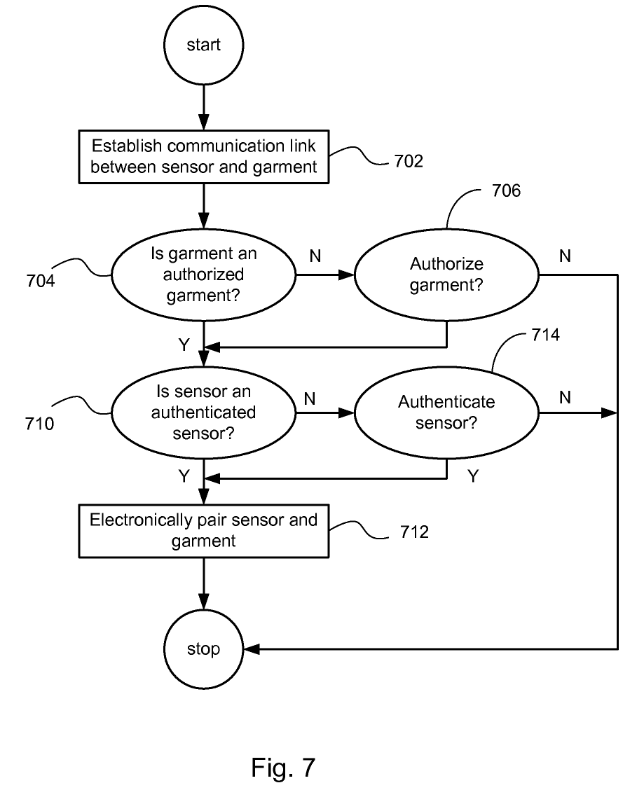

FIG. 7 shows a flowchart detailing a process 700 for electronically pairing a sensor and a garment in accordance with an embodiment of the invention. Process 700 begins at 702 by establishing a communication link between the garment and the sensor. The communication link can be a wireless communication link (RF, audio, etc.) or carried over a signal wire. In any case, once the communication link has been established, a determination is made at 704 if the garment is an authorized garment. By authorized it is meant that the garment has been identified for use with the sensor. For example, a clothing manufacturer may only want certain of its product line to belong to the class of garments that can electronically pair with a particular sensor. This may be due to any number of reasons, such as the garment must be specifically fabricated to be able to work with the sensor and therefore, not every garment would be suitable, or the manufacturer may only want those garments in a certain price range to be paired with the sensor.

If the garment is not authorized, then in one embodiment, an option can be provided at 706 for authorizing the garment by, for example, updating a list of authorized garment information to include the garment information of the unauthorized garment. This is particularly useful in those situations where, for example, a manufacturer wishes to update a product line that was heretofore has not been authorized to be used with the sensor. On the other hand, if the garment is authorized, then at 710 a determination is made if the sensor is an authenticated sensor. By authenticated it is meant that the sensor has been certified for use with the garment (or class of garments) that have been designed for use with the sensor. By assuring that only authenticated sensors are electronically paired with the garment, the likelihood that a stolen, lost, or otherwise compromised sensor can be used is substantially reduced. If the sensor is determined to be authenticated, then the sensor and garment are electronically paired at 712 thereby allowing sensing data associated with the paired garment to be transmitted by the sensor to external circuitry, such as a portable computing device. In some embodiments, if the sensor not authenticated, than an option to authenticate the sensor can be provided at 714. This is useful in situations where, for example, a previously lost sensor (and therefore rendered unauthenticated) has been found.

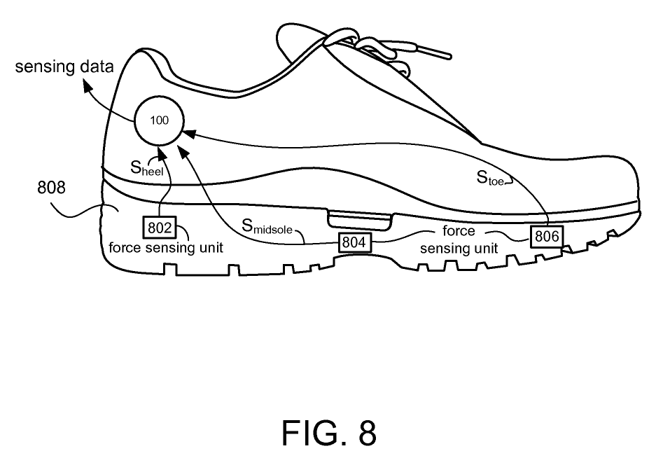

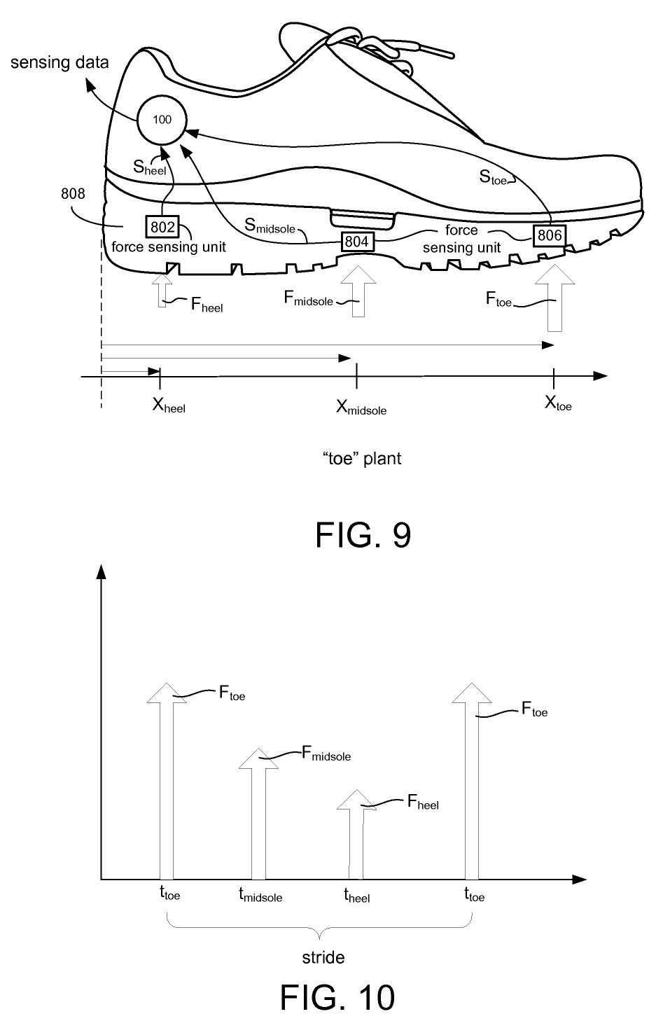

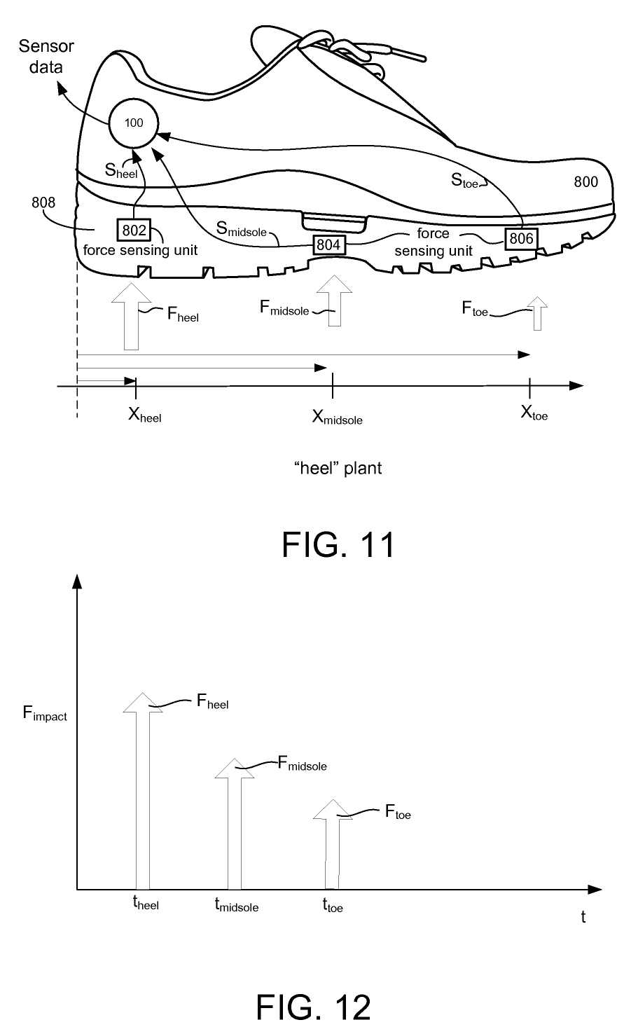

Sensor 100 can provide performance data that can be user to improve garment performance and/or user performance. FIG. 8 shows running shoe 800 that has been electronically paired with sensor 100 in accordance with an embodiment of the invention. Shoe 800 includes applied force sensing units 802, 804, and 806 placed in shoe sole 808 at heel location Xₕₑₑₗ, midsole location X_{midsole} and toe location Xₜₒₑ each arranged to respectively sense impact force Fₕₑₑₗ, F_{midsole}, and Fₜₒₑ. Sensors 802-806 each periodically send impact force sensing data Sₕₑₑₗ, S_{midsole}, and Sₜₒₑ to sensor 100 most of which is then forwarded to an external computing device, such as portable media player 404 for processing. Such processing can include characterizing a user's running style in real time. For example, by comparing the relative forces of impact (Fₜₒₑ vs. F_{midsole} vs. Fₕₑₑₗ) and the temporal relationship between the occurrence of the forces of impact Fₜₒₑ, F_{midsole}, and Fₕₑₑₗ (tₜₒₑ, t_{midsole}, tₕₑₑₗ), a user's stride can be characterized as either a toe plant type stride (see FIGS. 9 and 10) or a heel plant type stride (see FIGS. 11 and 12) where a user's stride can be defined as an amount of time between consecutive toe, heel, or mid-sole impacts for a particular shoe. Taken over a number of strides, a user's running style profile can be developed that provides a characterization of the user's overall running style.

Since, a runner's stride and stride type can vary over the course of a run (a sprint typically uses more of a toe plant style whereas a power walker would use more of a heel plant style), a user's running style profile can also vary over the course of the run (as well as well as over the course or months or years, or as the running shoes wear, or between different, but authorized, running shoes). Therefore, in order to more accurately gauge a user's overall running style, a user's average running style can be calculated. In some cases, the user's average running style is accumulated from a number of previous runs using the same running shoe or can incorporate average running styles from different (but authorized) running shoes, if desired. In this way, a user has the ability to compare running styles and/or performance not only from one run to another, but from one running shoe to another, or merely deduce an overall running style regardless of the running shoe used.

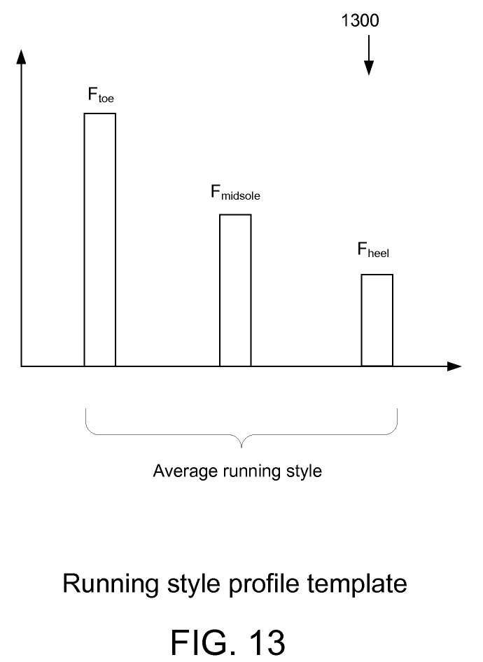

A virtual coach can provide real time feedback to a user either during or after a run by comparing a user's running style profile to a running style profile template 1300 as illustrated in FIG. 13. Running style template 1300 incorporates what could be considered an optimal running style profile for a particular user based upon age, gender, distances run, frequency of running, type of running (hills, intervals, flats, etc.) each modified for the particular running shoes used. By periodically comparing a user's real time running style profile to the appropriate optimal running style template, media player 404, for example, can provide real time coaching suggestions (i.e., “increase stride”, “decrease stride”, “increase toe plant”, “increase heel plant”, and so on) to the user during the run, for example, or after a run by providing a summation of user's running style and suggestions for how to modify it.

While this invention has been described in terms of a preferred embodiment, there are alterations, permutations, and equivalents that fall within the scope of this invention. It should also be noted that there are many alternative ways of implementing both the process and apparatus of the present invention. It is therefore intended that the invention be interpreted as including all such alterations, permutations, and equivalents as fall within the true spirit and scope of the present invention.

What is claimed is:

1. A method of electronically pairing a sensor and a garment, comprising:
(a) establishing a communication link between the sensor and the garment;
(b) determining if the garment is an authorized garment; and
(c) electronically pairing the garment and the sensor.

2. A method as recited in claim 1, further comprising:
(d) determining if the sensor is an authenticated sensor.

3. A method as recited in claim 1, wherein the determining (b) comprises: receiving garment identification information; and comparing the garment identification information to authorized garment identification information.

4. A method as recited in claim 1, further comprising:
receiving garment data by the sensor; and
passing most of the garment data to an external circuit for further processing.

5. A method as recited in claim 4, wherein the garment data includes a garment manufacture date, garment wear data, a garment wear threshold value.

6. A method as recited in claim 5 comprising:
comparing a current garment wear data value to the garment wear threshold value; and
issuing a wear notification based upon the comparison of the current garment wear data value and the garment wear threshold value.

7. A method as recited in claim 1, further comprising:
receiving user performance data by the sensor; and
passing most of the user performance to an external circuit for further processing.

8. A method as recited in claim 7, wherein when the garment is a shoe, then the user performance data includes stride data, force of impact data and corresponding location of impact data.

9. A method as recited in claim 8, further comprising:
calculating a user running style profile based upon the stride data, the force of impact data and the corresponding point of impact data;
comparing the user running style profile to a running style profile template; and
issuing virtual coaching instructions based upon the comparison of the user running style profile and the running style profile template.

10. A method as recited in claim 9, wherein the external circuit is a computing device arranged to process the received data.

11. A method as recited in claim 10, wherein the computing device is part of a network of computing devices.

12. A method as recited in claim 11, wherein most of the data is processed by at least one of the network of computing devices.

13. A method as recited in claim 12, wherein at least one of the computing devices is a personal portable computing device.

14. Computer program product executable by a processor for electronically pairing a sensor and a garment, comprising:
computer code for establishing a communication link between the sensor and the garment;
computer code for determining if the garment is an authorized garment;
computer code for electronically pairing the garment and the sensor; and
computer readable medium for storing the computer code.

15. Computer program product as recited in claim 14, further comprising: computer code for determining if the sensor is an authenticated sensor.

16. Computer program product as recited in claim 15, wherein the computer code for determining if the garment is an authorized garment further comprises:
computer code for receiving garment identification information; and
computer code for comparing the garment identification information to authorized garment identification information.

17. Computer program product as recited in claim 15, further comprising:
computer code for receiving garment data by the sensor; and
computer code for passing most of the garment data to an external circuit for further processing.

18. Computer program product as recited in claim 17, wherein the garment data includes a garment date of manufacture, garment wear data, a garment wear threshold value.

19. Computer program product as recited in claim 18 comprising:
computer code for comparing a current garment wear data value to the garment wear threshold value; and
computer code for issuing a wear notification based upon the comparison of the current garment wear data value and the garment wear threshold value.

20. Computer program product as recited in claim 15, further comprising:
computer code for receiving user performance data by the sensor; and
computer code for passing most of the user performance to an external circuit for further processing.

21. Computer program product as recited in claim 20, wherein when the garment is a shoe, then the user performance data includes stride data, force of impact data and corresponding location of impact data.

22. Computer program product as recited in claim 21, further comprising:
computer code for calculating a user running style profile based upon the stride data, the force of impact data and the corresponding point of impact data;
computer code for comparing the user running style profile to a running style profile template;
computer code for issuing virtual coaching instructions based upon the comparison of the user running style profile and the running style profile template.

23. Computer program product as recited in claim 22, wherein the external circuit is a computing device arranged to process the received data.

24. Computer program product as recited in claim 23, wherein the computing device is part of a network of computing devices.

25. Computer program product as recited in claim 24, wherein most of the data is processed by at least one of the network of computing devices.

26. Computer program product as recited in claim 25, wherein at least one of the computing devices is a personal portable computing device.

27. A system, comprising:
a sensor; and
a garment electronically paired with the sensor, wherein the sensor receives data from the garment and passes most of data to an external circuit for further processing.

28. A system as recited in claim 27, wherein the external circuit is a portable computing device in communication with the sensor.

29. A system as recited in claim 28, wherein the data received from the garment is user performance data.

30. A system as recited in claim 29, wherein when the garment is a shoe, then the user performance data includes stride data, force of impact data and corresponding location of impact data.

31. A system as recited in claim 30, wherein the further processing comprises:
calculating a user running style profile based upon the stride data, the force of impact data and the corresponding point of impact data;
comparing the user running style profile to a running style profile template;
issuing virtual coaching instructions based upon the comparison of the user running style profile and the running style profile template.

32. A system as recited in claim 31, wherein the portable computing device is part of a network of computing devices.

33. A system as recited in claim 32, wherein most of the user performance data is processed by at least one of the network of computing devices.

34. A system as recited in claim 33, wherein at least one of the computing devices is a portable multimedia player.
